(19) United States
(12) Patent Application Publication
(10) Pub. No.: US 2005/0213094 A1
(43) Pub. Date: Sep. 29, 2005

(54) Method and device for testing polarizers

(75) Inventors: Jye-Jong Chen, Pin Chen City (TW); Bor-Ping Wang, Pin Chen City (TW); Yu-Chung Liao, Pin Chen City (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/971,100

(22) Filed: Oct. 25, 2004

(30) Foreign Application Priority Data
Mar. 26, 2004 (TW) 93108229

(51) Int. Cl. G01J 4/00

(52) U.S. Cl. 356/364

(57) ABSTRACT

A polarizer testing device and method thereof, wherein the polarizer testing device comprises: a monochromatic light source capable of providing a monochromatic light; a light detecting module arranged according to the monochromatic light source capable of converting the light signal of the monochromatic light source into readable data; an adjustable base arranged between the monochromatic light source and the light detecting module capable of supporting a polarizer for testing and fine tuning the angle of the polarizer for testing, wherein the monochromatic light is detected by the light detecting module after passing through the polarizer for testing. A stationary base can be further arranged in the polarizer testing device, which the stationary base is arranged between the monochromatic light source and the adjustable base capable of supporting a polarized polarizer for the light to pass through to form a polarized light.

### FIELD OF THE INVENTION

The present invention relates to a method and a for testing polarizer, and more particularly, to a testing device and method that has at least 0.1 degree accuracy and is capable of providing the function of real-time on site testing so as to achieve the object of fast and accurate testing.

### BACKGROUND OF THE INVENTION

The liquid crystal molecules of the LCD panels sold in the current market are in a state between solid and liquid. That is, liquid crystals exist in a state that is transitional between that of a solid or liquid. In this intermediate state, liquid crystal molecules tend to point the same way, like the molecules in a solid, but can also move around to different positions, like the molecules in a liquid. This tendency of the liquid crystal molecules to point along a certain direction results in the liquid crystal displaying certain properties that are specific to the direction to which these properties are measured. This fundamental property of liquid crystals, called anisotropy, is what is exploited in the engineering of LCDs. Liquid crystals can also be further categorized by their specific structure and properties, such as the twisted nematic (TN) LCD, the super-TN (STN) LCD, and the thin film transistor (TFT-) LCD panels.

FIG. 1A is a schematic drawing of a conventional TN LCD panel before an external voltage is applied. FIG. 1B is a schematic drawing of a conventional TN LCD panel after an external voltage is applied. As seen in FIG. 1A, the TN LCD panel 100 mainly includes: two alignment films 110, 120 respectively with fine grooves 105, 106 formed by rubbing and two polarizers 130, 140 capable of polarizing incident light. When the nematic liquid crystal 150 is filled between the alignment films 110, 120, the liquid crystal is oriented along the direction of the grooves easily since the molecules of the nematic liquid crystal 150 possess the fluid property of the liquid. Since the nematic liquid crystal 150 in the vicinity of the grooves 105, 106 will be subjected to a larger binding force, it will be oriented along the direction of the grooves 105. 106. And since the nematic liquid crystal 150 in the center experiences a weaker binding force, its distribution can be twisted. It is called the Twisted Nematic type due to the fact that the nematic liquid crystal 150 between the alignment films 110, 120 is twisted 90 degrees. Therefore, without applying an external voltage between the alignment films 110, 120, the polarization of the light 160 passing through the polarizer 140 and the alignment film 120 will be rotated 90 degrees according to the distribution of the liquid crystal 150 so that it will match the polarizations of the alignment film 110 and the polarizer 130. As the result, the light can pass through the polarizer 130 successfully.

Please refer to FIG. 1B. When an external field is applied on the alignment films 110, 120, the nematic liquid crystal 150 tends to align parallel to the direction of the applied filed as seen in FIG. 1B The nematic liquid crystal 150 is now aligned perpendicularly to the surfaces of the alignment films 110, 120. Since the polarization of the light passing through the polarizer 140 and the alignment film 120 will not be rotated, the light can not pass through the polarizer 130.

In summary, the angle between the polarization directions of the polarizers 130, 140 is 90 degrees, and the accuracy of the angle affects the quality of the LCD panel greatly. Therefore, the accuracy of calibrating the angle between the polarizers is very important. However, the conventional calibrating method uses a machine purchased separately to test the angle between the polarizers. Due to the insufficient resolution of the light source, the error commonly exceeds 1 degree. Moreover, the polarizers have to be placed into that machine, which makes the manufacturing procedure more complicated.

In conclusion, the conventional polarizer testing device and method have at least the following disadvantages:
1. The accuracy of the testing the angle of the polarizer using the conventional machine is insufficient, such that the calibration quality is not assured.
2. The size of the polarizer that can be tested is limited by the specs of the machine used that different machines have to be used for different sizes of polarizers, which increases the cost of testing and the possibilities of misconduct.
3. The testing can not be automated on-site using the conventional machine, which lowers the testing efficiency and reduces the production rate.
4. When the size of the polarizer is changed, new machines have to be purchased and the testing technicians have to be retrained by using the conventional method, which increases the production cost.

### SUMMARY OF THE INVENTION

In view of the disadvantages of prior art, the primary object of the present invention is to provide a polarizer testing device and method thereof capable of increasing the testing accuracy to below 0.1 degrees to assure the testing quality.

The second object of the present invention is to provide a polarizer testing device and method thereof adaptable for testing polarizers of different sizes that the cost of testing and the possibility of making errors can be reduced.

It is another object of the present invention to provide an automatic on-site polarizer testing device and method thereof that can improve both the testing efficiency and the production rate.

Yet, another object of the present invention is to provide a polarizer testing device and method thereof adaptable for testing polarizers of different sizes that can avoid the cost of purchasing extra machine and training testing technicians so as to reduce the production cost.

To achieve the above-mentioned objects, the preferred embodiment of the present invention provides a polarizer testing device, comprising: a monochromatic light source, capable of generating a monochromatic light; a light detecting module, arranged according to the monochromatic light source, capable of converting the light signal of the monochromatic light source into readable data; an adjustable base, arranged between the monochromatic light source and the light detecting module, capable of supporting a polarizer for testing and fine tuning the angle of the polarizer, wherein the monochromatic light is detected by the light detecting module after passing through the polarizer for testing.

Wherein, the polarizer testing device further comprises: a stationary base, arranged between the monochromatic light source and the adjustable base, capable of supporting a polarizer for the monochromatic light to pass through. The monochromatic light source is a laser system.

In a polarizer testing method according to a preferred embodiment of the present invention, a polarizer for testing is arranged on an adjustable base and the method includes the following steps:
(a) Illuminating the polarizer for testing with a monochromatic light by a proper angle;
(b) Detecting the monochromatic light passing through the polarizer for testing to obtain a test value;
(c) Comparing the test value with a standard value;
(d) Adjusting the angle of the polarizer for testing by rotating the adjustable base so that the test value can approximate to the standard value.

### BRIEF DESCRIPTION OF THE DRAWINGS

FIG. 1A is a schematic drawing of a conventional twisted nematic LCD panel before applying an external field.

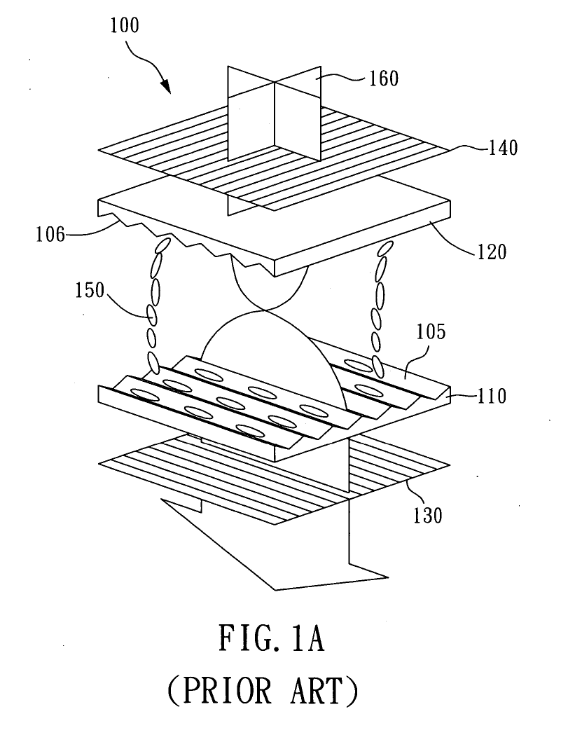

FIG. 1B is a schematic drawing of a conventional twisted nematic LCD panel after applying an external field.

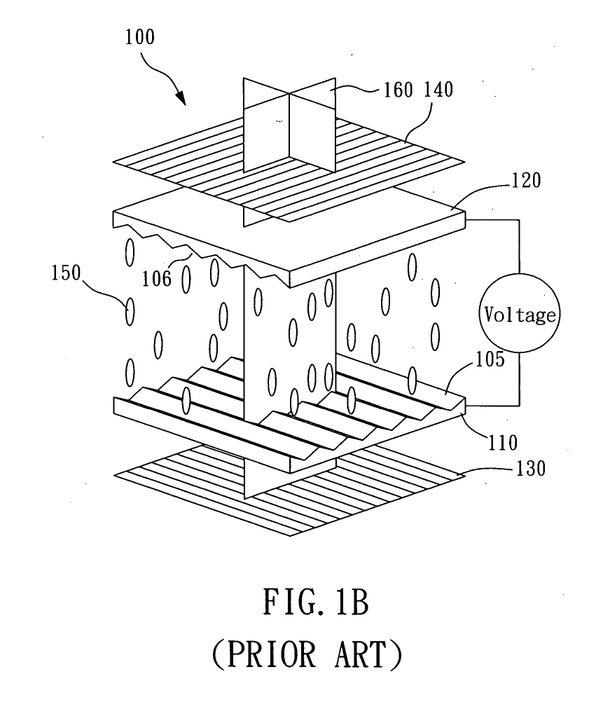

FIG. 2 is a schematic drawing of a polarizer testing device according to a first preferred embodiment of the present invention.

FIG. 3 is a flow chart of a polarizer testing method according to a first preferred embodiment of the present invention.

FIG. 4 is an intensity profile as a function of the angle of a according to a first preferred embodiment of the present invention.

FIG. 5 is a schematic drawing of a polarizer testing device according to a second preferred embodiment of the present invention

FIG. 6 is a flow chart of a polarizer testing method according to a second preferred embodiment of the present invention

### DESCRIPTION OF THE PREFERRED EMBODIMENT

With the following drawings, the objects, features, and advantages of the present invention are described in detail.

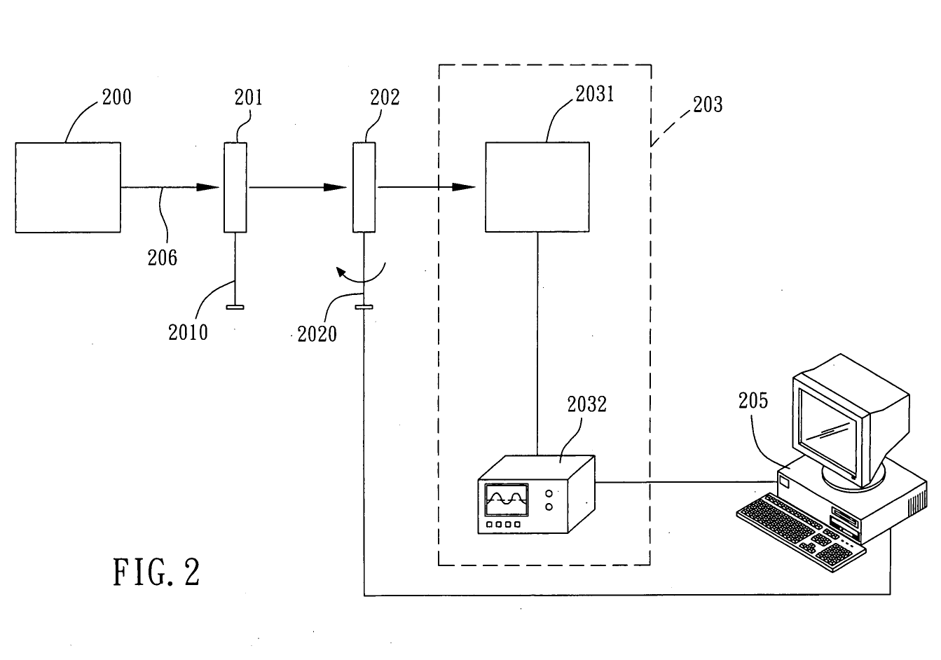

Please refer to FIG. 2, which is a schematic drawing of a polarizer testing device according to a first preferred embodiment of the present invention. The polarizer testing device of the present invention utilizes a monochromatic light source 200 to provide a monochromatic light. A laser system is used as the monochromatic light source 200 in the present invention. With the high resolution, high intensity, and the monochromaticity, the wavelength of the laser light 206 can be controlled in the range of 380 nm to 780 nm, which is in the range of a visible light so that the generated wave pattern can be seen and distinguishable by the examiner. Moreover, with the laser light 206 that has a resolution of 0.01 nm, the accuracy in testing the angle of the polarizers can be better than 0.1 degrees.

Next, the laser light 206 is directed to the polarizer 201 supported by a stationary base 2010 arranged between the monochromatic light source 200 and the adjustable base 2020. When the laser light 206 passes through the polarized polarizer 201, the polarization of the light becomes the same as the polarization of the polarizer 201. The stationary base 2010 is maintained in a fixed position through out the test to preserve the polarization of the laser light 206. The polarized laser light 206 is directed to the polarizer for testing supported by an adjustable base 202, which the adjustable base 2020 can fine tune the angle of the polarizer 202, or the polarization of the polarizer for testing 202. The polarized laser light 206 is then detected by a light detection module 203 arranged with respect to the monochromatic light source 200 for converting the laser light 206 into readable data.

Typically, the light detecting module 203 is composed of a light detecting unit 2031 and a light monitoring device 2032. Wherein, the light detecting unit 2031, typically a CCD, a CMOS, or a PMT, is capable of detecting the laser light 206; the light monitoring device 2032, typically an oscilloscope, is capable of converting the laser light 206 detected by the light detecting unit 2031 into readable data. A computer 205 can be connected to the light detecting module 203 as a recording and comparing device, wherein the computer 205 can record and compare the data from the light detecting module 203 and then control the adjustable base 2020 to adjust the polarization of the polarizer for testing 202.

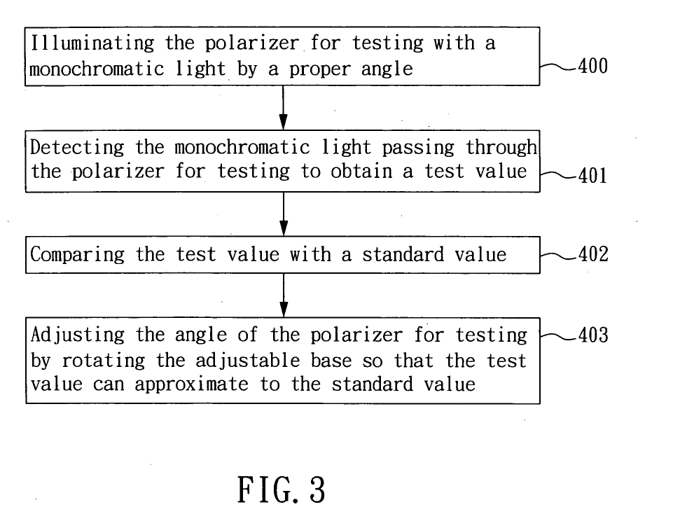

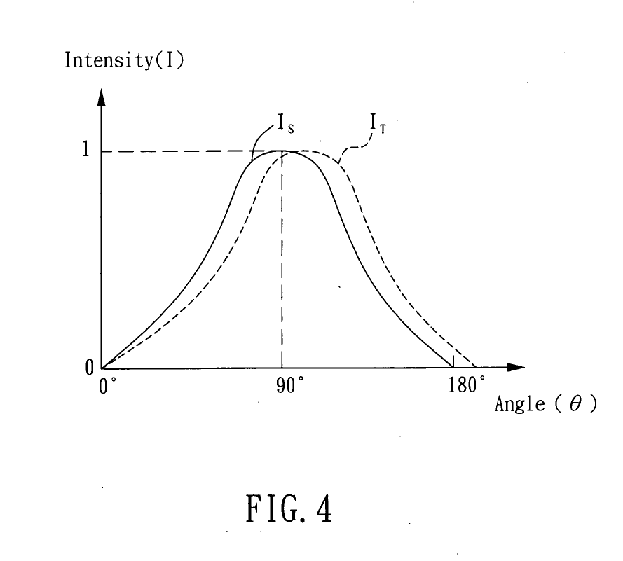

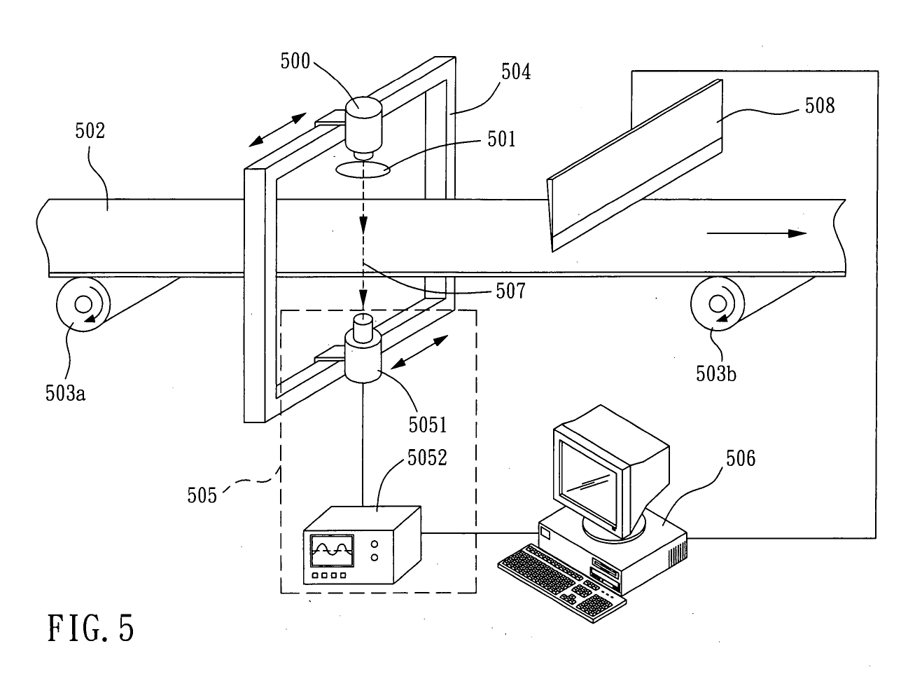

Please refer to FIG. 3 and FIG. 4, which are a flow chart and an intensity profile as a function of the angle of a polarizer according to a first preferred embodiment of the present invention, respectively, wherein a polarizer for testing is arranged on an adjustable base. The polarizer testing method of the preferred embodiment of the present invention includes the following steps:
Step 400: illuminating the polarizer for testing with a monochromatic light by a proper angle, wherein the monochromatic light is a laser light with wavelength ranged between 380 to 780 nm and resolution of 0.01 nm, and the proper angle can be a polarized light of either 90 degrees or 0 degree polarization direction.
Step 401: Detecting the monochromatic light passing through the polarizer for testing to obtain a test value as the curve Iₜ shown in FIG. 5, wherein the laser light detected by the light detecting module is converted into readable data for the computer to compare that the intensity profile as a function of the angle can be plotted showing the relation between the light intensity and the polarization angle.
Step 402: Comparing the test value with a standard value as the curve Iₛ shown in FIG. 5, which is the standard data of the relation between the intensity and the angle of the standard polarizer, wherein the polarization angle of the standard polarizer in the present preferred embodiment is 90 degrees that the curve Iₛ has a maximum intensity at 90 degrees and minima at 0 and 180 degrees.
Step 403: Adjusting the polarization angle of the polarizer for testing by rotating the adjustable base so that the test value can be approximated to the standard value, wherein by adjusting the polarization angle of the polarizer for testing with rotation, the curve Iₜ shown in FIG. 5 will shift toward curve Iₛ meaning that the polarization angle of the polarizer for testing is approximated to 90 degrees that the polarization angle of the polarizer for testing can therefore be marked, while this test can be done with the polarizers of any sizes.

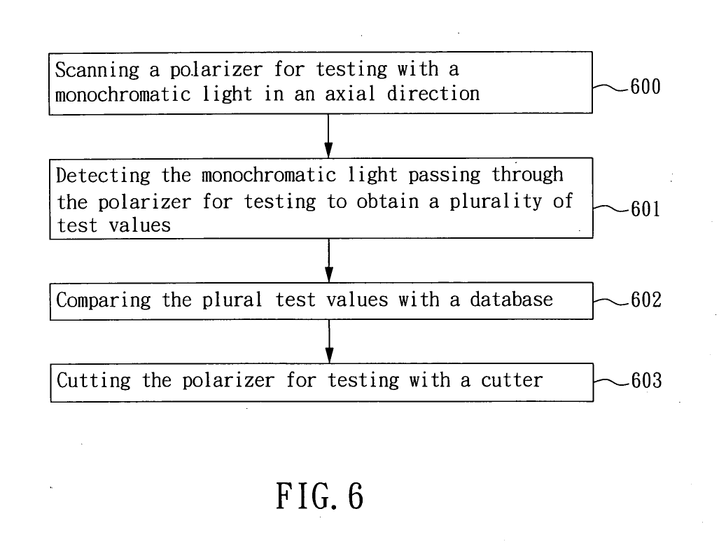

Please refer to FIG. 5, which is a schematic drawing of a polarizer testing device according a second preferred embodiment of the present invention. The monochromatic light source in the second preferred embodiment is a laser system as well. The function of the monochromatic light source is similar to the one described in the first preferred embodiment, which will be omitted here. The function of the polarizer 504 is also similar to the polarizer 201 described in the first preferred embodiment, which will be omitted here as well. Wherein, the polarizer for testing 502 is arranged on the transportation rollers 503a and 503b that the polarizer can be transferred from roller 503a to roller 503b. The monochromatic light source 500 on the movable stand 504 can move correspondingly with the light detecting module 505 so that the laser light 507 scanned through the polarizer for testing 502 can be detected by the light detecting module 505. The light detecting module 505 converts the laser light 507 detected into the readable data for the computer 506 to compare. The information of the cutting angle is then sent to the cutter 508 determining the cutting angle of the cutter 508. Accordingly, the testing procedure can be automated that the testing efficiency and the production rate can be increased. As shown in FIG. 6, which is a flow chart of a polarizer testing method depicting a second preferred embodiment of the present invention that includes the following procedures:
Step 600: scanning a polarizer for testing with a monochromatic light in an axial direction; wherein the monochromatic light source is a laser light with a wavelength in the range of 380 to 780 nm with a resolution better than 0.01 nm and the direction is the transverse direction of the polarizer for testing, wherein the light signals from the polarizer for testing at different locations can therefore be obtained by scanning transversely through the polarizer for testing while the width of the polarizer for testing is typically around 130 cm.
Step 601: detecting the monochromatic light passing through the polarizer for testing to obtain several test values, and converting the light signal of the, laser light (which is the monochromatic light source) into readable data with the light detecting module, wherein since the laser light scans the polarizer for testing in the transverse direction, the light signals of the polarizer at different locations can be converted into several test values for further comparisons and examinations.
Step 602: comparing the test values mentioned with a database, wherein the test values obtained at different locations are compared with the database in the recording and comparing device which the database contains the information of the relation between the intensity and the angle for various standard polarizers, and by cross comparison, the angle distribution of the polarizer for testing can then be obtained (while some errors in the angles obtained from the entire polarizer for testing may occur).
Step 603: cutting the polarizer for testing with a cutter, by knowing the angle distribution of the polarizer for testing from Step (c), the cutting angle of the cutter can be controlled to cut the polarizer for testing with a desire angle so that the polarizer for testing can have a higher accuracy that is less than 0.1 degrees.

In conclusion, a polarizer testing device and method thereof of the present invention is capable of improving the accuracy of the testing to below 0.1 degrees, testing polarizers with different sizes, and testing with automated on-site procedures that improves the efficiency of the testing and the production rate. Moreover, extra testing machines and retraining of the technicians are no longer necessary, which further reduce the production cost. The above-mentioned preferable embodiments are applied to describe the present invention in detail that, however, they are not the limited scope of the present invention. For example, using a polarized light with different polarization angle, removing the polarized polarizer, changing the rotation direction of the adjustable base, and etc. Therefore, it is apparent to all the persons who well-know such technologies that appropriate and small variation and adjustment still possess the merit of the present invention and is also still within the spirit and the scope of the present invention.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A polarizer testing device, comprising:
a monochromatic light source, capable of providing a monochromatic light;
a light detecting module, arranged with respect to said monochromatic light source, capable of converting the light signal of said monochromatic light into readable data;
an adjusted base, arranged between said monochromatic light source and said light detecting module, capable of supporting a polarizer for testing and fine tuning the angle of said polarizer for testing, wherein said monochromatic light is detected by said light detecting module after passing through said polarizer for testing.

2. The polarizer testing device according to claim 1, wherein said polarizer testing device further comprises:
a stationary base, arranged between said monochromatic light source and said adjustable base, capable of supporting a polarized polarizer for said monochromatic light to pass through.

3. The polarizer testing device according to claim 1, wherein said monochromatic light source is a laser system.

4. The polarizer testing device according to claim 1, wherein the wavelength of said monochromatic light is in the range of 380 to 780 nm.

5. The polarizer testing device according to claim 1, wherein the resolution of said monochromatic light is 0.01 nm.

6. The polarizer testing device according to claim 1, wherein said light detecting module comprises:
a light detecting unit, capable of detecting said monochromatic light;
a light signal monitoring device, connected to said light detecting unit, capable of converting the light signal of said monochromatic light into readable data.

7. The polarizer testing device according to claim 6, wherein said light detecting unit is a CCD.

8. The polarizer testing device according to claim 6, wherein said light detecting unit is a CMOS.

9. The polarizer testing device according to claim 6, wherein said light detecting unit is a PMT.

10. The polarizer testing device according to claim 6, wherein said light signal monitoring device is an oscilloscope.

11. The polarizer testing device according to claim 1, wherein said light detecting module is further connected to a recording/comparing device.

12. The polarizer testing device according to claim 11, wherein said recording/comparing device is a computer.

13. A polarizer testing method, wherein a polarizer for testing is arranged on an adjustable base, and the method comprises the steps of:
(a) illuminating said polarizer for testing with a monochromatic light by a predefined angle;
(b) detecting the monochromatic light passing through said polarizer for testing to obtain a test value;
(c) comparing said test value with a standard value;
(d) adjusting the polarization angle of said polarizer for testing by rotating said adjustable base so that said test value can approach said standard value.

14. The polarizer testing method according to claim 13, wherein said predefined angle in Step (a) is 90 degrees.

15. The polarizer testing method according to claim 13, wherein said predefined angle in Step (a) is 0 degrees.

16. The polarizer testing method according to claim 13, wherein said monochromatic light is a laser light.

17. The polarizer testing method according to claim 16, wherein the wavelength of said laser light is in the range of 380 to 780 nm.

18. The polarizer testing method according to claim 16, wherein the resolution of said laser light is 0.01 nm.

19. A polarizer testing device, comprising:
a movable stand;
a monochromatic light source, arranged on said movable stand, capable of providing a monochromatic light;
a light detecting module, arranged on said moveable stand at a position corresponding to said monochromatic light source, capable of converting the light signal of said monochromatic light into readable data;
wherein, a polarizer for testing is arranged between said monochromatic light source and said light detecting module, and said monochromatic light source and said light detecting module can move accordingly so that said monochromatic light that passes through said polarizer for testing can be detected by said light detecting module.

20. The polarizer testing device according to claim 19, wherein said polarizer testing device further comprises:
a polarized polarizer, arranged between said monochromatic light source and said polarizer for testing for said monochromatic light to pass through.

21. The polarizer testing method according to claim 19, wherein said monochromatic light is a laser system.

22. the polarizer testing method according to claim 19, wherein the wavelength of said monochromatic light is in the range of 380 to 780 nm.

23. The polarizer testing method according to claim 19, wherein the resolution of said monochromatic light is 0.01 nm.

24. The polarizer testing device according to claim 19, wherein said light detecting module comprises:
a light detecting unit, capable of detecting said monochromatic light;
a light signal monitoring device, connected to said light detecting unit, capable of converting the light signal of said monochromatic light into readable data.

25. The polarizer testing device according to claim 24, wherein said light detecting unit is a CCD.

26. The polarizer testing device according to claim 24, wherein said light detecting unit is a CMOS.

27. The polarizer testing device according to claim 24, wherein said light detecting unit is a PMT.

28. The polarizer testing device according to claim 24, wherein said light signal monitoring device is an oscilloscope.

29. The polarizer testing device according to claim 19, wherein said light detecting module is further connected to a recording/comparing device.

30. The polarizer testing device according to claim 29, wherein said recording/comparing device is a computer.

31. The polarizer testing device according to claim 29, wherein a cutter can be further connected to said recording and comparing device.

32. A polarizer testing method, comprising the steps of:
(a) scanning a polarizer for testing with a monochromatic light in a transverse direction;
(b) detecting the monochromatic light that passes through said polarizer for testing to obtain a plurality of test values;
(c) comparing said plural test values with a database.

33. The polarizer testing method according to claim 32, wherein said procedures after Step (c) further includes:
(d) cutting said polarizer for testing with a cutter.

34. The polarizer testing method according to claim 32, wherein said monochromatic light is a laser light.

35. The polarizer testing method according to claim 34, wherein the wavelength of said laser light is in the range of 380 to 780 nm.

36. The polarizer testing method according to claim 34, wherein the resolution of said laser light is 0.01 nm.
